(19) United States
(12) Patent Application Publication
(10) Pub. No.: US 2023/0232728 A1
(43) Pub. Date: Jul. 27, 2023

(54) FIELD MANAGEMENT MACHINE

(71) Applicant: Chongqing Hwasdan Agricultural Equipment Manufacturing Co., Ltd., Chongqing City (CN)

(72) Inventors: Peng XIAN, Chongqing City (CN); Guo YI, Chongqing City (CN); Dechao SU, Chongqing City (CN)

(21) Appl. No.: 17/825,015

(22) Filed: May 26, 2022

(30) Foreign Application Priority Data
Jan. 27, 2022 (CN) 202210102911.X

(51) Int. Cl. A01B 33/08; A01B 33/02; A01B 33/12; A01B 33/14; F16H 61/16; F16H 59/10

(52) U.S. Cl. CPC A01B 33/082; A01B 33/022; A01B 33/028; A01B 33/12; A01B 33/142; F16H 61/16; F16H 59/10; F16H 2059/0295

(57) ABSTRACT

A field management machine includes a rack, a driver, a transmission, traveling wheels, a cutter, and a gear shift lever. A first shift fork controls gear shift of the cutter. A second shift fork controls gear shift of the traveling wheels. The gear shift lever includes a traveling gear shift lever and a cutter gear shift lever. The cutter gear shift lever is connected to the first shift fork. The traveling gear shift lever is connected to the second shift fork. The field management machine includes a trigger rod between the cutter gear shift lever and the traveling gear shift lever. The trigger rod is connected to the cutter gear shift lever or the traveling gear shift lever. The traveling gear shift lever pushes the trigger rod when the traveling gear shift lever is switched to a reverse gear to shift the cutter gear shift to a neutral gear.

### TECHNICAL FIELD

The present invention relates to the technical field of agricultural machinery, and in particular to a field management machine.

### BACKGROUND ART

The current agricultural machinery, represented by the field management machine, has the functions of rotary tillage, ditching and hilling, with certain differences between the rotating speed of the cutter and the traveling speed of the entire apparatus during the operation of rotary tillage, ditching, hilling, etc, and different cutter speeds or traveling speeds are selectable according to different soil structures. To better adapt field management machine to use demands of different situations, the existing field management machine includes an engine, a transmission, traveling wheels and a cutter, where the engine is used for providing power for the transmission, the transmission is used for making the traveling wheels and the cutter configured with different gears, different gears are switched by means of a control lever mounted on the field management machine, a traveling gear shift lever of the field management machine can control the traveling wheels to advance (i.e. forward gear), retreat (i.e. reverse gear) or idle (i.e. neutral gear), and a cutter gear shift lever can control the cutter to rotate (i.e. working gear) and idle (i.e. neutral gear).

In actual operation, misoperations are possible by the operators. For example, the operator mistakenly shifts the traveling gear shift lever controlling the traveling wheels from the state of the neutral gear to the state of the reverse gear, and if the cutter is still in the working state (in such a case, the cutter gear shift lever controlling cutter gears is engaged in the working gear) but the traveling wheels are in the reverse gear, the cutter continue rotating, posing danger to the operator; and to avoid the situation that the cutter still rotates while the traveling wheels are in reverse gear in the prior art, a safety mechanism is configured, and if the traveling wheels is required to be in reverse gear, the safety mechanism must be operated first such that the traveling wheels can be in the state of the reverse after the cutter is in a neutral gear.

However, although the operation in prior art can prevent the traveling gear shift lever from switching the reverse gear when the cutter is not in neutral gear, and avoid the shifting to reverse gear of the traveling wheels caused by misoperation, the operation to engage the reverse gear for the traveling wheels with actual demands becomes troublesome.

### SUMMARY

The present invention aims to provide a field management machine, so as to solve the problems that potential safety hazards are caused by misoperation of a reverse gear of traveling wheels by an operator and that troublesome operation is caused due to the configuration of the safety mechanism ensures that the traveling wheels may be switched to a reverse gear only in a state of a neutral gear of a cutter in the prior art.

To achieve the above objective, the basic solution of the present invention is as follows:

a field management machine includes a rack, a driver, a transmission, traveling wheels, a cutter and a gear shift lever, where the transmission includes a gearbox and a cutter output shaft and a traveling output shaft which are rotatably connected to the gearbox, the driver is used for driving the cutter output shaft and the traveling output shaft to rotate, the cutter output shaft is used for driving the cutter to rotate, and the traveling output shaft is used for driving the traveling wheels to rotate; a first shift fork for controlling gear shift of the cutter and a second shift fork for controlling gear shift of the traveling wheels are connected to the gearbox, and the gear shift lever includes a traveling gear shift lever and a cutter gear shift lever, the cutter gear shift lever being connected to the first shift fork, and the traveling gear shift lever being connected to the second shift fork; and the field management machine further includes a trigger rod located between the cutter gear shift lever and the traveling gear shift lever, the trigger rod being fixedly connected to the cutter gear shift lever or the traveling gear shift lever, and the traveling gear shift lever pushes the trigger rod when the traveling gear shift lever is switched to a reverse gear, such that the cutter gear shift lever is shifted to a state of a neutral gear.

Beneficial effects compared with the prior art are as follows:

when the solution is adopted, power is provided for the transmission by the driver, the purpose of adjusting cutter gears is achieved by adjusting a state of the first shift fork by means of the cutter gear shift lever, and the purpose of adjusting traveling wheel gears is achieved by adjusting a state of the second shift fork by means of the traveling gear shift lever. If in actual operation, no matter whether an operator mistakenly operates a traveling reverse gear or actively operates the traveling reverse gear to make the traveling gear shift lever shifted to a position of a reverse gear, the trigger rod is pushed in a process of switching the traveling gear shift lever, such that the cutter gear shift lever is forced to be shifted to a state of a neutral gear, and on one hand, operation of shifting the traveling wheels to the reverse gear is simple; and on the other hand, the cutter is automatically switched to the state of the neutral gear when the reverse gear is mistakenly operated, thereby avoiding the problem that the cutter still rotates in a state of the reverse gear of the traveling wheels, posing danger to the operator.

Further, the transmission includes the gearbox, where a mounting plate is fixed on the gearbox, strip-shaped limiting holes having the same operation direction as the cutter gear shift lever and the traveling gear shift lever are provided on the mounting plate, the cutter gear shift lever and the traveling gear shift lever are both located in the strip-shaped limiting holes, and the trigger rod is located below the mounting plate.

Beneficial effects are as follows: the cutter gear shift lever and the traveling gear shift lever are guided during gear shifting by means of the strip-shaped limiting holes on the mounting plate, thereby improving gear shifting stability favorably, and moreover, the mounting plate shields and protects the trigger rod above the trigger rod, thereby reducing probability that the trigger rod is damaged by the outside.

Further, a main shaft is rotatably connected to an interior of the gearbox, and is connected to an output end of the driver, a shift gear is axially and slidably connected to the main shaft, the first shift fork is used for pushing the shift gear to move axially, and a fixed gear engaging with the shift gear is fixedly connected to the cutter output shaft; and a main gear is further fixedly connected to the main shaft, a transmitting gear further sleeves the cutter output shaft in an empty mode, auxiliary gears is mounted on the traveling output shaft, and the transmitting gear engages with the main gear and the auxiliary gears.

Beneficial effects are as follows: when the solution is adopted, a working gear and a neutral gear of the cutter output shaft are enabled by means of axial movement of the shift gear, for example, when the shift gear engages with the fixed gear, the cutter output shaft rotates to drive the cutter to rotate, and when the shift gear does not engage with the fixed gear, the cutter output shaft has no output, such that the cutter is in the state of the neutral gear. A traveling speed of the traveling wheels is far lower than a rotating speed of the cutter, and therefore, the transmitting gear and the auxiliary gears are used for reducing a speed of the traveling output shaft, and moreover, in the solution, the transmitting gear for reducing the speed of the traveling wheels sleeves the cutter output shaft in an empty mode to reasonably utilize the cutter output shaft, and compared with the circumstance that a rotating shaft is additionally configured, the solution may make the structure more compact, thereby further reducing an overall size of the entire transmission, facilitating miniaturization and light weight of the transmission, and further facilitating miniaturization and light weight of the entire field management machine.

Further, the transmitting gear includes a first transmitting gear and a second transmitting gear which sleeve the cutter output shaft in an empty mode, the auxiliary gears include a first auxiliary gear and a second auxiliary gear, the first auxiliary gear sleeves the traveling output shaft in an empty mode, the second auxiliary gear being axially and slidably connected to the traveling output shaft, the second shift fork is used for pushing the second auxiliary gear to move in an axial direction, and the first transmitting gear, the second transmitting gear and the first auxiliary gear each include a large gear and a pinion which are fixedly connected, where the large gear of the first transmitting gear engages with the main gear, the pinion of the first transmitting gear engages with the large gear of the first auxiliary gear, the pinion of the first auxiliary gear engages with the large gear of the second transmitting gear, and the pinion of the second transmitting gear may engage with the second auxiliary gear.

Beneficial effects are as follows: when the solution is adopted, each time of engaging between the pinions and the large gears is speed reduction, power passes through the main gear, the first transmitting gear, the first auxiliary gear, the second transmitting gear and the second auxiliary gear sequentially in a process of transmitting power to the traveling output shaft from the main shaft by means of arrangement of the main shaft, the cutter output shaft and the traveling output shaft in the solution, and the power is subjected to four-stage speed reduction in the process of transmitting the power, such that under the condition that a size of the transmission is not increased, an axial space of each shaft on the transmission is utilized to a greater extent, and moreover, an output rotating speed of the traveling output shaft of a driving system is further significantly reduced, and a traveling speed of the field management machine is more suitable for actual agricultural production operation.

A reverse gear is further rotatably connected to the gearbox, the second transmitting gear is further provided with a matching gear engaging with the reverse gear, and the second auxiliary gear may further engage with the reverse gear.

Beneficial effects are as follows: when the solution is adopted, by means of arrangement of the reverse gear, the second shift fork pushes the second auxiliary gear to move along the traveling output shaft by operating the traveling gear shift lever when steering of the traveling output shaft is required to be changed until the second auxiliary gear engages with the reverse gear, further, the power sequentially passes through the main gear, the first transmitting gear, the first auxiliary gear, the second transmitting gear and the reverse gear from the main shaft and finally is transmitted to the second auxiliary gear synchronously rotating with the traveling output shaft, thereby changing a direction (i.e. reverse gear) of the traveling output shaft, and the solution has a simple solution, such that the reverse gear is still subjected to multi-stage speed reduction, thereby ensuring that the reverse gear is in a low-speed state, and contributing to improvement of operation safety.

A transition gear set is further rotatably connected to the interior of the gearbox and includes a first transition gear and a second transition gear which are fixedly connected, the fixed gear on the cutter output shaft constantly engages with the first transition gear, and the shift gear may engage with the second transition gear.

Beneficial effects are as follows: when the solution is adopted, the cutter output shaft has three states by means of arrangement of the transition gear set, one state is that the cutter shift gear does not engage with any gear, and in such a case, the cutter output shaft is in an idle state; after the cutter shift gear engages with the fixed gear, the power of the main shaft is directly transmitted to the cutter output shaft, such that the cutter output shaft outputs one kind of power; and after the cutter shift gear engages with the second transition gear, power is transmitted to the second transition gear of the transition gear set through the cutter shift gear, and then the power is transmitted to the cutter output shaft by means of the first transition gear coaxially and fixedly connected to the second transition gear, such that a rotating direction of the cutter output shaft is modified, and moreover, a rotating speed of the cutter output shaft is modified by means of intervention of the transition gear set, thereby satisfying agricultural operation with different requirements on the same field management machine, further achieving function diversity of the field management machine, reducing apparatus cost, avoiding the situation that two apparatuses are required to be transferred when rotary tillage and ditching and hilling are carried out on the same day, and improving working efficiency favorably.

In addition, in the solution, by means of the arrangement of the transition gear set, the rotating speed of the cutter output shaft in different states is modified, thereby further satisfying actual use requirements.

A speed change cavity and a traveling cavity are provided in the gearbox, the main shaft, the traveling output shaft and the cutter output shaft are all located in the speed change cavity, a traveling shaft is rotatably connected to a cavity wall of the traveling cavity, and the traveling wheels are fixedly connected to the traveling shaft; and a transmitting gear is configured between the traveling shaft and the traveling output shaft and is located in the traveling cavity.

Beneficial effects are as follows: the gearbox in the prior art includes a transmitting gearbox and the lower traveling box, where the transmitting gearbox is used for accommodating a clutch and a driving structure of a transmission, a vertical transmission shaft and a horizontal traveling shaft are configured in the lower traveling box, the traveling shaft is used for driving the traveling wheels to rotate, the transmission shaft is used for transmitting power of the driving structure of the transmission to the traveling shaft, and due to existence of the lower traveling box, the entire field management machine has a large height, and may not perform mechanical automatic agricultural operation due to a limited height of the space between the crop leaves and the ground (also called as below the crops) for crops with branches and leaves shorter than the ground. When the solution is adopted, the main shaft, the traveling output shaft and the cutter output shaft are all located in the speed change cavity to complete mounting of the driving structure of the transmission, the traveling shaft fixedly connected to the traveling wheels directly rotates on the cavity wall of the traveling cavity, and moreover, by means of design of the gearbox and the transmitting gear connection design of the traveling shaft and mounting of the traveling output shaft, the driving structure of the transmission and the traveling shaft are mounted on one gearbox, such that on one hand, the solution omits the lower traveling box in the prior art, thereby significantly reducing cost of the gearbox, and achieving miniaturization and light weight of the gearbox; and on the other hand, the lower traveling box is omitted, such that a height of the entire field management machine is significantly reduced, and the field management machine in the solution may directly perform mechanical automatic operation in the space below the crops with branches and leaves shorter than the ground, thereby solving the problems in the prior art, and contributing to the improvement of agricultural operation efficiency.

Further, the cutter includes a left cutter assembly and a right cutter assembly which are symmetrically mounted, where the left cutter assembly and the right cutter assembly each includes a blade shaft and a plurality of blades, the plurality of blades are sequentially distributed in an axial direction of the corresponding blade shaft, an axial distance between adjacent blades is equal, the plurality of blades are uniformly distributed on a vertical surface of the corresponding blade shaft in a circumferential direction of the blade shaft by 360°, and the plurality of blades on the same blade shafts face the same directions.

Beneficial effects are as follows: hard soil when the field management machine performs rotary tillage operation, an existing cutter cuts soil in a mode that a plurality of blades penetrate into soil simultaneously, but the plurality of blades penetrate into the soil simultaneously, such that torque provided by the engine is dispersed to the plurality of blades, and when local soil is hard in an operation process, there is an phenomenon that it is difficult to uniformly arrange hard soil due to insufficient soil penetration force of the corresponding blades exists, such that there are obvious pits on a surface of the ploughed soil.

When the solution is adopted for operation, the plurality of blades are distributed in the axial directions of the blade shafts and are distributed in the circumferential directions of the vertical surfaces of the blade shafts by 360°, every time the two symmetrical blades on the left cutter assembly and the right cutter assembly are cut into the soil, and the torque provided by the driver acts on the two symmetrical blades making contact with the soil every time when the blades enter the soil, thereby ensuring that every two symmetrical blades break the soil with the strongest force, and significantly improving a cutting strength of the blades to the soil, and soil crushing may be smoothly completed even if the blades face the hard soil, such that the ploughed soil is flat, thereby solving the problem that it is difficult to uniformly arrange hard soil due to the insufficient soil penetration force of the cutter in the prior art, resulting in obvious pits on the surface of the soil.

In addition, in the solution, the plurality of blades are uniformly distributed on the vertical surfaces of the blade shafts in the circumferential directions of the blade shafts, and are distributed in the axial directions of the blade shafts, such that there is no situation that a plurality of blades are mounted on the same vertical surface of a blade shaft in the prior art, such that agricultural apparatuses rush and idle, the number of the blades is small and cost is lower while it is ensured that the cutter in the solution has better cutting force, only one blade penetrates into the soil on the same vertical surfaces of the blade shafts or on the same planes in which the blade shafts are located when the left cutter assembly and the right cutter assembly which are symmetrically configured penetrates into the soil every time, thereby significantly reducing probability of forward rushing or idle rotation of the traveling wheels of agricultural machinery apparatuses even if the soil is ploughed on hard soil, and moreover, when being used, a rotary blade has more balanced stress, smoother ploughed land, and small overall vibration when the land is ploughed, thereby significantly improving control performance of the agricultural machinery apparatuses using the rotary blades.

Further, blade boxes are fixed on the blade shafts, the number of the blade boxes is the same as that of the blades, insertion holes are provided on the blade boxes, blade handles of the blades are inserted into the insertion holes, and the blades are detachably connected to the blade boxes.

Beneficial effects are as follows: the blade boxes are detachably connected to the blades, such that replacement cost of the blades is low after the blades are damaged, and an assembly process between the blades and the blade boxes is simple.

Further, the blade shafts are in a shape of a regular polygon, the number of edges of each of the blade shafts is the same as that of the blades mounted, and the blade boxes make contact with two adjacent surfaces of the blade shafts simultaneously.

Beneficial effects are as follows: the number of the blades is the same as that of the edges of each of the blade shafts, and the blade boxes make contact with two adjacent surfaces of the cutter shafts simultaneously such that torque on the blade shafts may act on the blade boxes by means of the two surfaces simultaneously, and finally, the torque is transmitted to the blades from the blade boxes, such that cutting forces generated by the blades is maximum when the blades cut the soil, thereby prolonging service life of the blades and the blade boxes favorably.

Further, connecting lines of the plurality of blades on each of the blade shafts are two spiral lines, an included angle between the two spiral lines is 180°, and a distance between end projections of the two spiral lines in an axial direction of each of the blade shafts is equal to the distance between adjacent blades.

Beneficial effects are as follows: by means of arrangement of the two spiral lines, the blades corresponding to the two spiral lines are mounted at an angle of 180°, and a distance between ends of the two spiral lines is equal to the distance between adjacent blades, such that when the cutter is used for crushing the soil, after the blades on one spiral line completes soil crushing, the blades on a corresponding 180° position on the other spiral line are used for crushing the soil, and the alternate 180° soil crushing mode has a higher soil crushing rate and smoother ploughed soil, and is particularly suitable for ploughing sandy land or soft soil.

Further, each of the traveling wheels includes a tire and hubs, where the tires sleeve the hubs, a plurality of ground gripping teeth are configured on treads of each of the tires and are distributed in a circumferential direction of the tire, tooth heights of the ground gripping teeth are 0.15-0.28 times of radii of the treads, and widths of the hubs are 0.3-0.45 times of diameters of the treads of the tires.

Beneficial effects are as follows: in the prior art, traveling wheels of a field management machine use a mode of iron wheels and a mode of rubber wheels, when the iron wheels serve as the traveling wheels, the iron wheels have an excellent ground gripping effect when traveling on the land, however, when the iron wheels travel on a road, the iron wheels directly collide with the road, and the road, the iron wheels and the road are both easily damaged; in addition, the iron wheels have poor stability during traveling; and in order to solve the problems of the iron wheels, the rubber wheels are used for replacing the iron wheels to travel, and the rubber wheels have excellent abrasion resistance, but have a poor ground gripping effect, such that the field management machine is prone to slip during operation. To solve the above problem, the field management machine in the prior art is generally provided with the iron wheels and the rubber wheels simultaneously, the rubber wheels are used when the field management machine travels on the road, and the iron wheels are used when the field management machine travels on the land, but this mode increases replacement cost, and reduces production efficiency of the field management machine, and in addition, the iron wheels and the rubber wheels are carried simultaneously, thereby bringing trouble to carrying.

The traveling wheels in the solution use structures having the tires and the hubs, such that the whole traveling wheels are the rubber wheels, and compared with the iron wheels, abrasion resistance of the solution is excellent, and abrasion is not prone to occur; and the plurality of ground gripping teeth having tooth heights 0.15 time-0.28 time of the radius of the tread are configured on the tread of each of the tires, the ground gripping teeth have high heights, and may be inserted into the land, and a contact area between the ground gripping teeth and the land is large, such that the traveling wheels have an excellent ground gripping effect, thereby avoiding the problem that the rubber wheels in the prior art have a poor ground gripping effect and are prone to slip, and it may be seen that the traveling wheels of the solution give consideration to abrasion resistance and the ground gripping effect, and moreover, achieves the effects of the iron wheels and the existing common rubber wheels, thereby significantly reducing use cost.

In addition, the widths of the hubs are configured to be 0.3-0.45 times of the diameters of the treads of the tires, such that widths of the tires and the widths of the hubs are large, weight of the whole traveling wheels is increased, and increase of the weight is beneficial to improving a ground gripping force of the traveling wheels, and overcomes the defect that dead weight of a light-weight field management machine is reduced, such that the ground gripping force of the light-weight field management machine is weakened.

Further, the tires are solid, and are thicker in middles and thinner at both ends in longitudinal sections, and the two ends of the tires are supported by rims.

Beneficial effects are as follows: when the solution is adopted, the solid tires are beneficial to increasing density of the tires, such that the weight of the traveling wheels is larger, thereby improving the ground gripping force of the traveling wheels favorably; and in addition, the solid tires do not are required to be subjected to inflation treatment like the prior art, such that there is no situation of tire burst, thereby avoiding the maintenance problem caused by tire burst.

In addition, the tires are thick in the middles and thin at the two ends, thereby facilitating forming of the tire, and moreover, the middles of the tires are easier to abrade, and the service life of the traveling wheels is prolonged favorably by increasing thicknesses of the middles of the tires.

### BRIEF DESCRIPTION OF THE DRAWINGS

FIG. 1 is a three-dimensional structural schematic diagram of Embodiment 1 of the present invention;

FIG. 2 is a three-dimensional structural schematic diagram embodying a position relation among a gearbox, a gear shift lever and a cutter in FIG. 1;

FIG. 3 is a front view of FIG. 2;

FIG. 4 is a three-dimensional structural schematic diagram after a cutter is removed and a gearbox is cut away in FIG. 2;

FIG. 5 is a schematic diagram embodying a gearbox and an internal driving structure in FIG. 4;

FIG. 6 is a three-dimensional structural schematic diagram of a transmission in Embodiment 1 of the present invention after a gearbox is removed;

FIG. 7 is a front view of FIG. 6;

FIG. 8 is a rear view of FIG. 6;

FIG. 9 is a left view of FIG. 6;

FIG. 10 is a schematic diagram embodying a driving structure related to cutter gear control in Embodiment 1 of the present invention;

FIG. 11 is a schematic diagram embodying a driving structure related to traveling wheel gear control in Embodiment 1 of the present invention;

FIG. 12 is a front view of FIG. 11;

FIG. 13 is an isometric diagram of a cutter in Embodiment 2 of the present invention after a cutter shaft is removed and then blades are configured in a single spiral line mode;

FIG. 14 is a front view of FIG. 13;

FIG. 15 is a left view of FIG. 13;

FIG. 16 is an isometric diagram with blades removed in FIG. 13;

FIG. 17 is an isometric diagram of blades in Embodiment 2 of the present invention after the blades are configured in a double spiral line mode;

FIG. 18 is an isometric diagram after the blades are removed in FIG. 17;

FIG. 19 is an isometric diagram of Embodiment 3 of the present invention;

FIG. 20 is a front view of FIG. 19;

FIG. 21 is a left view of FIG. 19; and

FIG. 22 is a cutaway view A-A in FIG. 20.

### DETAILED DESCRIPTION OF THE EMBODIMENTS

The present invention will be further described in detail below by means of specific implementations:

Reference numbers in the drawings of the description include: gearbox 1, clutch cavity 11, speed change cavity 12, traveling cavity 13, mounting plate 14, first strip-shaped limiting hole 15, second strip-shaped limiting hole 16, traveling wheel 2, tire 21, hub 22, shaft sleeve 23, ground gripping tooth 24, buffer channel 25, connecting plate 26, radial plate 221, rim 222, cutter 3, left cutter assembly 31, right cutter assembly 32, blade shaft 311, blade box 312, blade 313, insertion hole 314, engine 4, main shaft 5, shift gear 51, main gear 52, traveling output shaft 6, first auxiliary gear 61, second auxiliary gear 62, cutter output shaft 7, fixed gear 71, first transmitting gear 72, second transmitting gear 73, matching gear 74, intermediate shaft 8, first transition gear 81, second transition gear 82, reverse gear shaft 9, reverse gear 91, clutch 10, first shift fork 20, second shift fork 30, traveling gear shift lever 40, cutter gear shift lever 50, traveling shaft 60, first bevel gear set 63, cutter shaft 70, and second bevel gear set 75.

### Embodiment 1

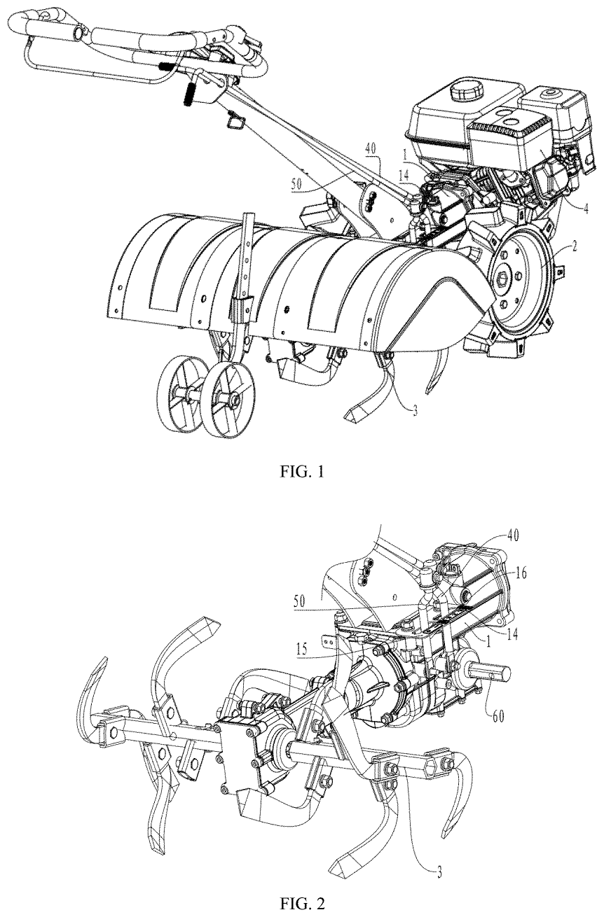

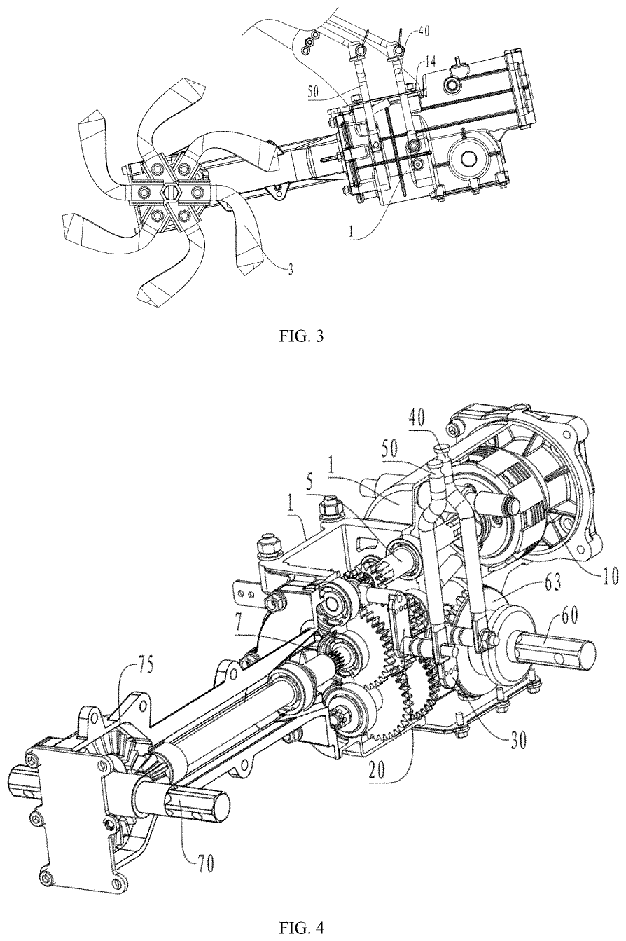

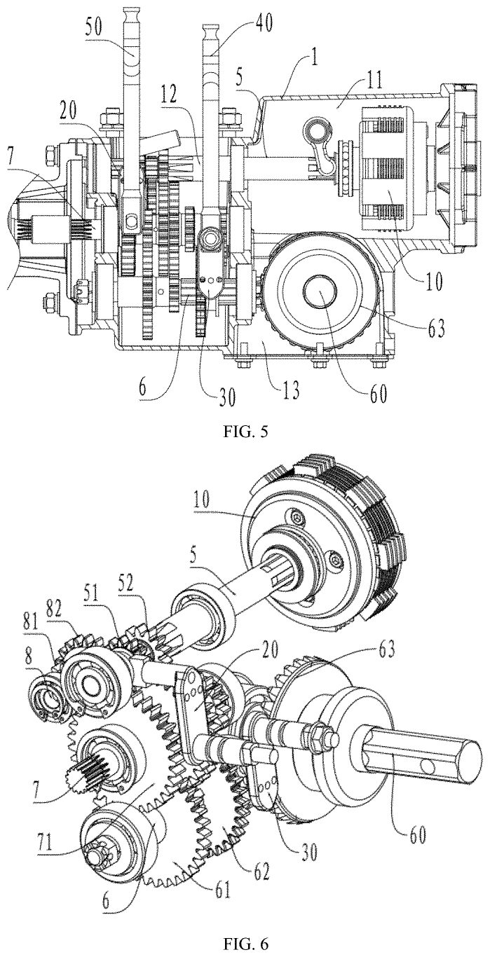

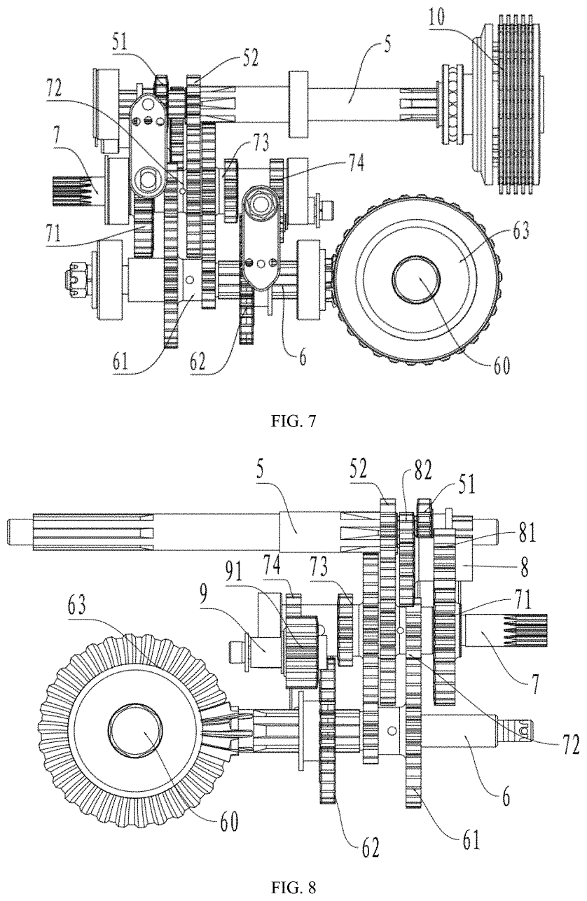

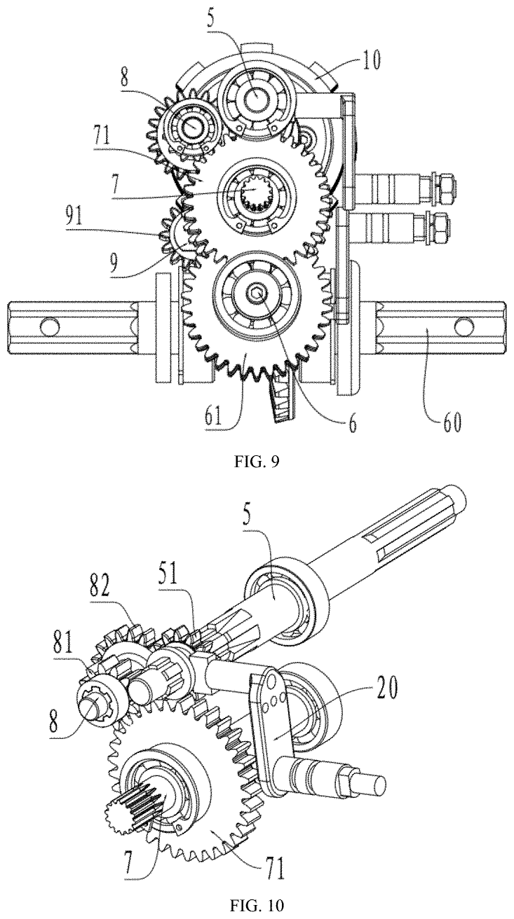

Embodiment 1 is basically as shown in FIGS. 1-12. A field management machine includes a rack, a driver, a transmission, traveling wheels 2, a cutter 3 and a gear shift lever, where the driver and the transmission are fixedly mounted on the rack, the driver is used for providing power for the transmission, and an engine 4 may be used for the driver in this embodiment.

With reference to FIGS. 2-9, the transmission includes a gearbox 1, and a main shaft 5, a traveling output shaft 6, a cutter output shaft 7, an intermediate shaft 8 and a reverse gear shaft 9 which are rotatably connected to the gearbox 1, where a clutch 10 is connected between the driver and the main shaft 5, the traveling output shaft 6 drives the traveling wheels 2 to rotate, and the cutter output shaft 7 drives the cutter 3 to rotate; and a clutch cavity 11, a speed change cavity 12 and a traveling cavity 13 which are in communication with one another pairwise are integrally formed in the gearbox 1, the clutch cavity 11 and the traveling cavity 13 are located on the same side of the speed change cavity 12, the clutch cavity 11 is used for accommodating the clutch 10, and the speed change cavity 12 is used for accommodating the main shaft 5, the traveling output shaft 6, the cutter output shaft 7, the intermediate shaft 8 and the reverse gear shaft 9.

A first shift fork 20 for controlling gear shift of the cutter 3 and a second shift fork 30 for controlling gear shift of the traveling wheels 2 are rotatably connected to the gearbox 1, and the first shift fork 20 and the second shift fork 30 each include a shift block and a rotating shaft, where the rotating shafts are rotatably connected to the gearbox 1, and penetrate the gearbox 1; and the gear lever includes a traveling gear shift lever 40 and a cutter gear shift lever 50, where the cutter gear shift lever 50 is fixedly connected to the rotating shaft of the first shift fork 20, and the traveling gear shift lever 40 is fixedly connected to the rotating shaft of the second shift fork 30.

Specifically, with reference to FIG. 10, a shift gear 51 is axially and slidably connected to the main shaft 5, the first shift fork 20 is used for pushing the shift gear 51 to move in an axial direction of the main shaft 5, a fixed gear 71 is fixedly connected to the cutter output shaft 7, the intermediate shaft 8 is sleeved with a transition gear set in an empty mode and includes a first transition gear 81 and a second transition gear 82 which are integrally formed, the fixed gear 71 constantly engages with the first transition gear 81, and the shift gear 51 may engage with the fixed gear 71 or the second transition gear 82 under the pushing of the first shift fork 20.

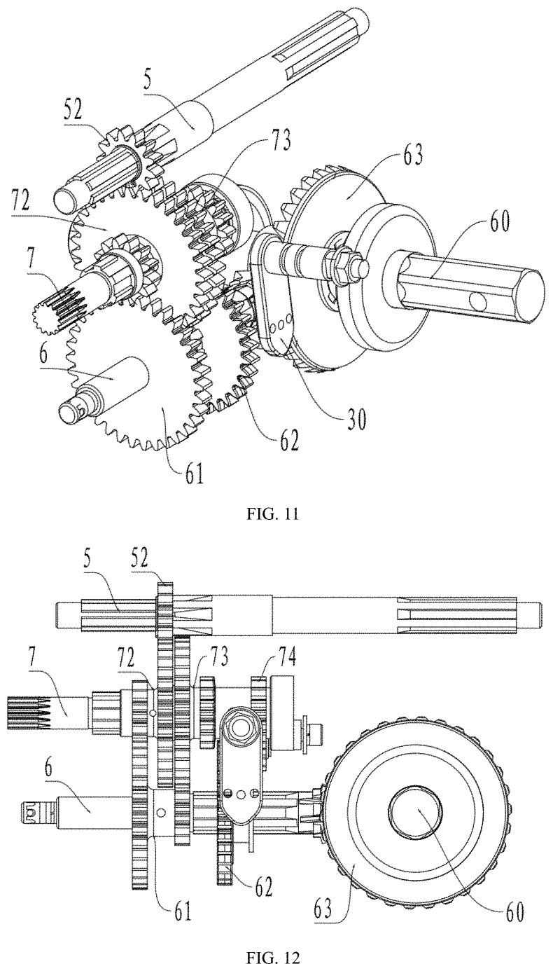

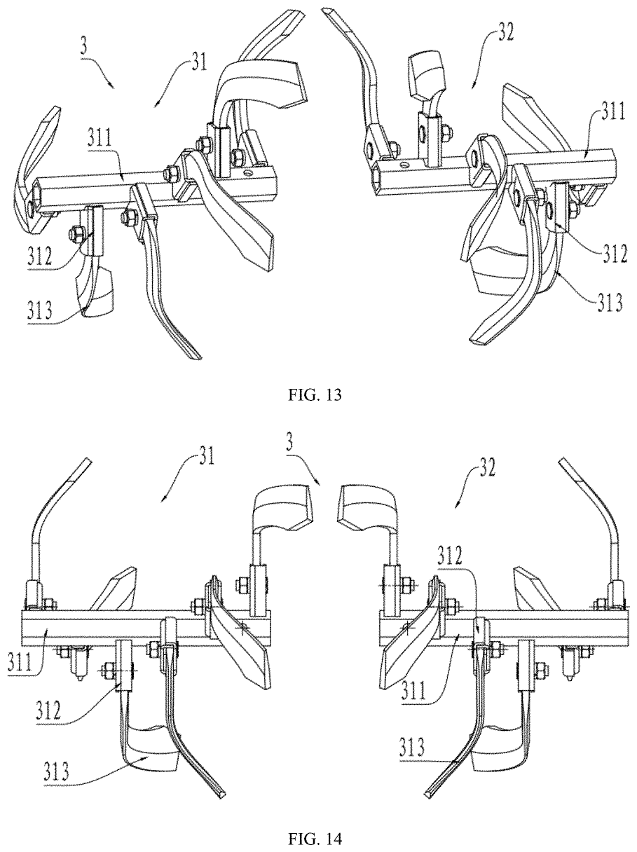

With reference to FIGS. 11 and 12, a main gear 52 is fixedly connected to the main shaft 5, the cutter output shaft 7 is further sleeved with a first transmitting gear 72 and a second transmitting gear 73 in an empty mode, auxiliary gears are mounted on the traveling output shaft 6, and the auxiliary gears include a first auxiliary gear 61 and a second auxiliary gear 62, where the first auxiliary gear 61 sleeves the traveling output shaft 6 in an empty mode, the second auxiliary gear 62 is axially and slidably connected to the traveling output shaft 6, and the second shift fork 30 is used for pushing the second auxiliary gear 62 to move in an axial direction.

The first transmitting gear 72, the second transmitting gear 73 and the first auxiliary gear 61 each include a large gear and a pinion which are integrally formed, where the large gear of the first transmitting gear 72 engages with the main gear 52, the pinion of the first transmitting gear 72 engages with the large gear of the first auxiliary gear 61, the pinion of the first auxiliary gear 61 engages with the large gear of the second transmitting gear 73, and the pinion of the second transmitting gear 73 may engage with the second auxiliary gear 62.

The large gear of the first transmitting gear 72 and the large gear of the second transmitting gear 73 are located in a middle of a transmitting gear, the pinion of the first transmitting gear 72 and the pinion of the second transmitting gear 73 are located on two sides of the transmitting gear, and a receding space is formed between the large gear and the pinion of the first auxiliary gear 61, and is used for receding the large gear of the first transmitting gear 72, such that an internal structure of the entire transmission is more compact, thereby facilitating miniaturization and light weight of the transmission.

The reverse gear shaft 9 is sleeved with a reverse gear 91 in an empty mode, a matching gear 74 engaging with the reverse gear 91 is further integrally formed on the second transmitting gear 73 (the matching gear 74 is completely the same as the pinion on the second transmitting gear 73, and the second transmitting gear 73 and the matching gear 74 form triple teeth), the matching gear 74 is integrally formed with the large gear and the pinion on the second transmitting gear 73, and the second auxiliary gear 62 may engage with the reverse gear 91.

The reverse gear 91 and the transition gear set are located on the two sides of the transmitting gear.

A traveling shaft 60 is rotatably connected to a cavity wall of the traveling cavity 13, a driving gear is configured between the traveling shaft 60 and the traveling output shaft 6, the driving gear uses a first bevel gear set 63, the first bevel gear set 63 is located below the main shaft 5, the first bevel gear set 63 is located in the traveling cavity 13, and the traveling shaft 60 and a bevel gear in the first bevel gear set 63 rotate synchronously. A cutter shaft 70 is further rotatably connected to the rack, transmission between the cutter shaft 70 and the cutter output shaft 7 is achieved by means of a second bevel gear set 75, and the cutter shaft 70 is fixedly connected to the cutter 3.

A trigger rod is configured between the cutter gear shift lever 50 and the traveling gear shift lever 40, the trigger rod is fixedly connected to the cutter gear shift lever 50 or the traveling gear shift lever 40, the trigger rod in this embodiment is welded to the cutter gear shift lever 50, and the trigger rod is pushed by the traveling gear shift lever 40 when the traveling gear shift lever 40 is switched to a reverse gear, such that the cutter gear shift lever 50 is shifted to a state of a neutral gear.

A mounting plate 14 is fixed on the gearbox 1, strip-shaped limiting holes having the same operation direction as the cutter gear shift lever 50 and the traveling gear shift lever 40 are configured on the mounting plate 14, the cutter gear shift lever 50 and the traveling gear shift lever 40 are both located in the strip-shaped limiting holes, and the trigger rod is located below the mounting plate 14. Lengths of the strip-shaped limiting holes may limit an operation range of the cutter gear shift lever 50 and the traveling gear shift lever 40 such that gears of the cutter gear shift lever 50 and the traveling gear shift lever 40 are adjustable on the basis of arrangement of the strip-shaped limiting holes, so a sot meet different use requirements of different crowds on the field management machine. For example, when the lengths of the strip-shaped limiting holes are long enough, all the gears of the cutter gear shift lever 50 and the traveling gear shift lever 40 are adjustable; when the lengths of the strip-shaped limiting holes are short, part of the gears may not be achieved, for example, in this embodiment, the strip-shaped limiting holes are configured into two holes which are named as a first strip-shaped limiting hole 15 and a second strip-shaped limiting hole 16 respectively, the cutter gear shift lever 50 is located in the first strip-shaped limiting hole 15, the traveling gear shift lever 40 is located in the second strip-shaped limiting hole 16, in order to make the cutter 3 have a working gear and a neutral gear, a length of the first strip-shaped limiting hole 15 is smaller than that of the second strip-shaped limiting hole 16, so as to make the cutter 3 on the field management machine have a neutral gear and a working gear, and the traveling wheels 2 have a forward gear, a reverse gear and a neutral gear.

A specific implementation is as follows:

When this embodiment is adopted, the field management machine may achieve the working gear and the neutral gear of the cutter 3 and the forward gear, the reverse gear and the neutral gear of the traveling wheels 2, and specific gear working conditions are as follows:

1, the working gear of the cutter 3 is as follows: the first shift fork 20 rotates by pushing the cutter gear shift lever 50, such that the shift block of the first shift fork 20 pushes the shift gear 51 to move to a state of engaging with the second transition gear 82, further, power of the main shaft 5 is transmitted to the second transition gear 82 through the shift gear 51, then the power is transmitted to the fixed gear 71 through the first transition gear 81, and the fixed gear 71 rotates, such that the cutter output shaft 7 rotates, so as to drive the cutter 3 to rotate for operation.

2, the neutral gear of the cutter 3 is as follows: the first shift fork 20 rotates by pushing the cutter gear shift lever 50, such that the shift gear 51 does not engage with any gear, and no power is transmitted to the cutter output shaft 7 to achieve the neutral gear of the cutter output shaft 7, such that when the field management machine is transferred, only the traveling wheels 2 are required to be started, thereby avoiding the situation that the cutter output shaft 7 drives the cutter 3 to rotate, and further threatening safety of an operator.

3, the forward gear of the traveling wheels 2 is as follows: the second shift fork 30 rotates by pushing the traveling gear shift lever 40, and further, the shift block of the second shift fork 30 pushes the second auxiliary gear 62 to move, so as to make the second auxiliary gear 62 engage with the pinion of the second transmitting gear 73, such that power of the engine 4 sequentially passes through the main gear 52, the first transmitting gear 72, the first auxiliary gear 61 and the second transmitting gear 73 from the main shaft 5 and is finally transmitted to the second auxiliary gear 62, in which each time of power transmission is speed reduction, and further, four stages of speed reduction are carried out in a process that the main shaft 5 transmits the power to the traveling output shaft 6 having the second auxiliary gear 62, thereby significantly reducing an output rotating speed of the traveling output shaft 6, and the traveling output shaft 6 transmits the power to the traveling shaft 60, such that the rotating speed of the traveling shaft 60 having the traveling wheels 2 is reduced, and a traveling speed of the traveling wheels 2 of the field management machine is more suitable for actual agricultural operation.

4, the neutral gear of the traveling wheels 2 is as follows: when the traveling wheels 2 is required to be in the neutral gear, the traveling output shaft 6 is required to have no power, in such a case, the traveling gear shift lever 40 is pushed to make the second shift fork 30 rotate, and the shift block of the second shift fork 30 pushes the second auxiliary gear 62 to move to a state of not engaging with any gear.

5, the revers gear of the traveling wheels 2 is as follows: the second shift fork 30 rotates by pushing the traveling gear shift lever 40, further, the shift block of the second shift fork 30 pushes the second auxiliary gear 62 to move to engage with the reverse gear 91, and further, the power sequentially passes through the main gear 52, the first transmitting gear 72, the first auxiliary gear 61, the second transmitting gear 73 and the reverse gear 91 from the main shaft 5 and is finally transmitted to the second auxiliary gear 62 which synchronously rotates with the traveling output shaft 6, thereby changing a direction of the traveling output shaft 6, and after the direction of the traveling output shaft 6 is modified, a direction of the traveling shaft 60 is driven by the first bevel gear set 63 to be changed along with the traveling output shaft, and the traveling wheels 2 configured on the traveling shaft 60 reversely rotate, thereby achieving the reverse gear of the traveling wheels 2.

When this embodiment is adopted, a space below the main shaft 5 is utilized, such that the horizontally configured traveling shaft 60 may directly and coaxially rotate with one bevel gear in the first bevel gear set 63, and further, the traveling shaft 60 and other shafts of the field management machine may be placed in the same box shell, thereby significantly reducing an occupied area of the whole gearbox 1 of the field management machine, and the traveling shaft 60 is horizontally configured, such that the traveling wheels 2 may be directly mounted on the traveling shafts 60, and compared with the circumstance that a field management machine in the prior art includes the transmitting gearbox 1 and the lower traveling box for mounting a driving shaft and a traveling shaft 60, this embodiment may omits the lower traveling box of the field management machine, thereby further improving miniaturization and light weight of the field management machine.

In addition, in this embodiment, the driving structure of the transmission, the clutch 10 and the traveling shaft 60 are configured in different cavities of the gearbox 1, such that mounting of the driving structure of the transmission and mounting of the traveling shaft 60 are completed on one gearbox 1, and on one hand, this embodiment omits the lower traveling box in the prior art, thereby reducing cost of the gearbox 1, and achieving miniaturization and light weight of the gearbox 1; and on the other hand, the lower traveling box is omitted, such that the height of the entire field management machine is significantly reduced, and the field management machine in the scheme may directly perform mechanical automatic operation in the space below crops with branches and leaves shorter than the ground, thereby solving the problem in the prior art, and improving agricultural operation efficiency.

In actual operation, no matter whether an operator mistakenly operates a traveling reverse gear or actively operates the traveling reverse gear 40 to make the traveling gear shift lever shifted to a position of a reverse gear, the trigger rod is pushed in a process of switching the traveling gear shift lever 40, such that the cutter gear shift lever 50 is forced to be shifted to a state of a neutral gear, and on one hand, operation of shifting the traveling wheels 2 to the reverse gear is simple; and on the other hand, the cutter 3 is automatically switched to the state of the neutral gear when the reverse gear is mistakenly operated, thereby avoiding the problem that the cutter 3 still rotates in a state of the reverse gear of the traveling wheels 2, such that danger is posed to an operator.

In addition, before the field management machine is used, another gear of the cutter 3 may be achieved on the basis that other components except the mounting plate 14 are not replaced according to specific use requirements, for example, the mounting plate 14 with a longer length of the first strip-shaped limiting hole 15 is selected, so as to make the cutter gear shift lever 50 rotate the first shift fork 20 to a state in which the shift gear 51 is moved to directly engage with the fixed gear 71 on the cutter output shaft 7, in which speed reduction transmission of a pair of gears is reduced in power transmission, such that the rotating speed of the cutter 3 may be higher, and engaging of the gears is reduced once, such that a rotating direction of the cutter 3 is modified, such that the field management machine in the solution may be suitable for different operation requirements, thereby increasing use functions of the field management machine.

### Embodiment 2

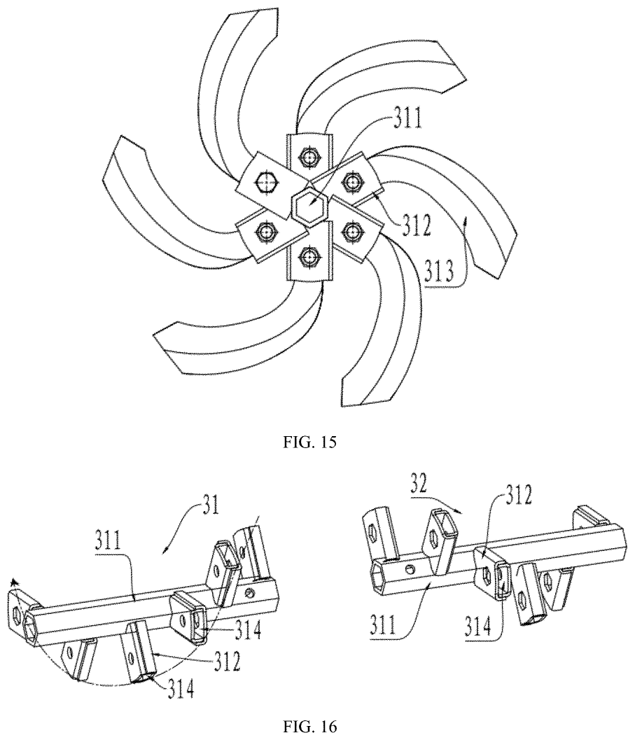

Embodiment 2 is basically as shown in FIGS. 13-18, Embodiment 2 further improves a cutter 3 on the basis of embodiment 1, and the specific improvement is as follows: the cutter 3 includes a left cutter assembly 31 and a right cutter assembly 32 which are symmetrically mounted, where the left cutter assembly 31 and the right cutter assembly 32 each include a blade shaft 311, blade boxes 312 and blades 313, where the blade shafts 311 of the left cutter assembly 31 and the right cutter assembly 32 are driven by a cutter output shaft 7, the cutter shafts 311 are in a shape of a regular polygon, the number of the blade boxes 312 and the number of the blades 313 are equal, the plurality of blade boxes and the plurality of blades are configured, the plurality of blades 313 on the same blade shafts 311 face the same directions, and the number of edges of each of the blade shafts 311 is the same as that of the blades 313 mounted. In this embodiment, the blade shafts 311 are in the shape of the regular hexagon, the blade shafts 311 are inserted into a cutter shaft 70 and are fixedly connected to the cutter shaft 70, and the six blade boxes 312 and the six blades 313 on the same blade shaft 311 are configured. The blade boxes 312 make contact with two adjacent surfaces of the blade shafts 311 simultaneously, and end surfaces of the blade boxes 312 connected to the blade shafts 311 are V-shaped.

Each of the blade boxes 312 includes two U-shaped plates, where every two U-shaped plates are welded to form insertion holes 314 for inserting the blades 313 in an enclosed mode, and the blades 313 are fixedly connected to the blade boxes 312 by means of bolts.

Each of the blades 313 includes a blade handle and a bent blade body, where the blade handles are used for being inserted into the insertion holes 314, the blade bodies are bent towards one sides of the blade shafts 311, cutting edges are formed on the blade bodies, and projections of the cutting edges of all the blades 313 on the same cutter shafts 3111 on axes of the blade shafts 311 are continuous.

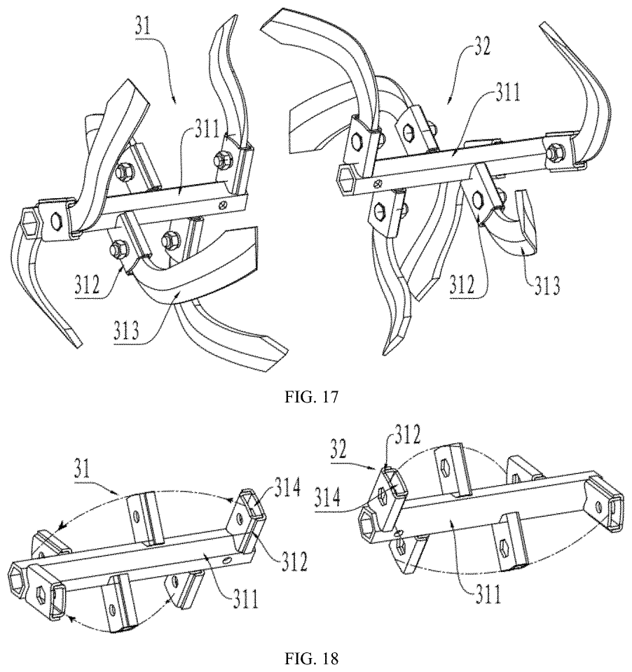

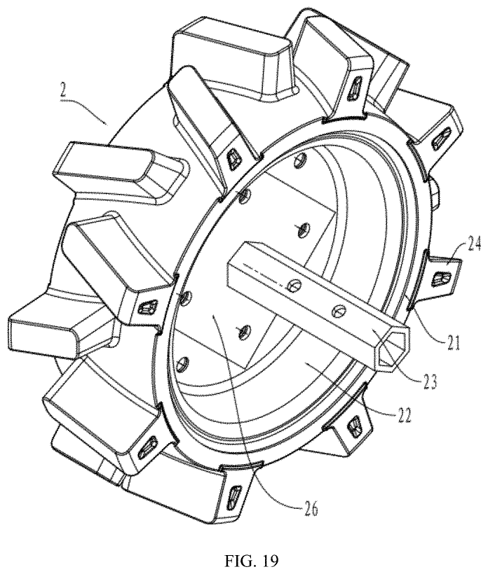

The six blades 313 are sequentially distributed in an axial direction of each of the blade shafts 311, the six blades 313 are uniformly distributed on a vertical surface of each of the blade shafts 311 in a circumferential direction of the blade shaft 311 by 360°, the connecting line of the six blades 313 on each of the blade shafts 311 is in a spiral line, an axial distance between adjacent blades 313 is equal, in this embodiment, FIGS. 13-16 are the situation in which the connecting line of the six blades 313 is in the single spiral line, FIGS. 17 and 18 are the situation in which the connecting lines of the six blades 313 are in the two spiral lines, an included angle between the two spiral lines is 180°, and a distance between projections of ends of the two spiral lines in the axial direction of each of the blade shafts 311 is equal to the distance between adjacent blades 313.

A specific implementation is as follows:

the cutter 3 in the single spiral line is taken as an example, and when the cutter 3 rotates, the blade shafts 311 rotate, such that the blade boxes 312 and the blades 313 rotate along with the blade shafts, and the plurality of blades 313 are distributed in the axial directions of the blade shafts 311 and distributed in circumferential directions of vertical surfaces of the blade shafts 311 by 360°, such that two symmetrical blades 313 on the left cutter assembly and the right cutter assembly are cut into soil every time, and when the blades 313 enter the soil every time, torque provided by the field management machine acts on the two symmetrical blades 313 making contact with the soil, thereby ensuring that every two symmetrical blades 313 break the soil with the strongest force, and significantly improving a cutting strength of the blades 313 to the soil, soil crushing may be smoothly completed even in hard soil, and the blades 313 for successively crushing the soil are single blades 313 for regularly and orderly crushing the soil, such that ploughed soil is flat, thereby solving the problem that soil penetration forces of rotary blades in the prior art are not enough and it is difficult to uniformly arrange hard soil, such that there are obvious pits in a surface of the soil.

In this embodiment, the plurality of blades 313 are uniformly distributed on the vertical surfaces of the blade shafts 311 in the circumferential directions of the blade shafts 311, the plurality of blades 313 are axially distributed along the blade shafts 311, such that there is no situation that a plurality of blades 313 are mounted on the same vertical surface of a blade shaft 311, and such that agricultural machinery apparatuses rush and idle in the prior art, and therefore, compared with an existing rotary blade, a rotary blade of this embodiment has the less number of blades 313 and lower cost while ensuring a better cutting force. In addition, only one blade 313 enters the soil when the left cutter assembly 31 and the right cutter assembly 32 which are symmetrically configured in this embodiment enter the soil every time on the vertical surfaces of the same blade shafts 311 or the same planes in which the cutter shafts 311 are located, thereby significantly reducing probability of forward rushing of the traveling wheels 2 or idle rotation of the traveling wheels 2 of agricultural machinery apparatuses even if the soil is ploughed on hard soil, and moreover, when being used, the rotary blade has more balanced stress, smoother ploughed land, and small overall vibration when the land is ploughed, thereby significantly improving control performance of the agricultural machinery apparatuses using the rotary blades.

The cutter 3 having the double spiral lines differs from the cutter having the single spiral line in that due to arrangement of the double spiral lines of the blades 313, the blades 313 corresponding to the two spiral lines are mounted at an angle of 180°, and the distance between the ends of the two spiral lines is equal to the distance between adjacent blades 313, such that when the rotary blade breaks the soil, after the blades 313 on one spiral line complete soil crushing, the blades 313 on a position of 180° corresponding to the other spiral line break the soil, and compared with the cutter 3 having the single spiral line, the alternate 180° soil crushing mode has a higher crushing rate and smoother ploughed soil, and is particularly suitable for ploughing sandy land or soft soil.

### Embodiment 3

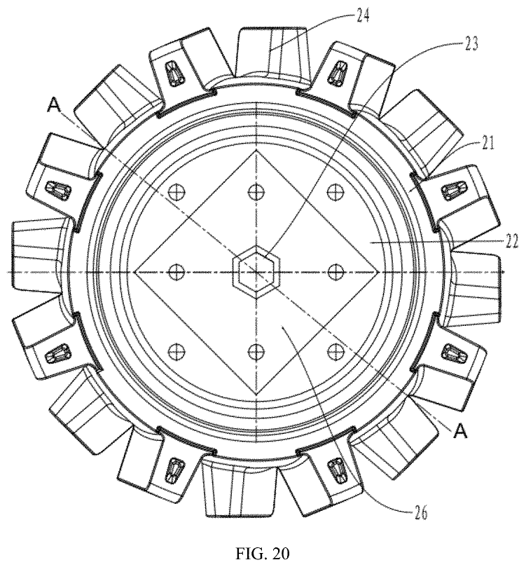

Embodiment 3 is basically as shown in FIGS. 19-22, Embodiment 3 improves traveling wheels 2 on the basis of Embodiment 1, which is specifically as follows: each of the traveling wheels 2 includes a tire 21, hubs 22 and a shaft sleeve 23, where the tires 21 are solid tires, the hubs 22 are made of metal, the tires 21 sleeves the hubs 22, and the shaft sleeves 23 are fixedly connected to the hubs 22.

A plurality of ground gripping teeth 24 are integrally formed on a tread of each of the tires 21, the ground gripping teeth 24 are distributed in a circumferential direction of each of the tires 21, tooth heights of the ground gripping teeth 24 are 0.15 time-0.28 time of radii of the treads, the tooth heights of the ground gripping teeth 24 in this embodiment is 25 mm-35 mm, and diameters of the treads of the tires 21 are 250 mm-270 mm. Widths of the hubs 22 are 0.3-0.45 times of the diameters of the treads of the tires 21, and the widths of the hubs 22 in this embodiment are 90 mm-11 mm.

Each of the hubs 22 includes a left hub 22 and a right hub 22, where the left hubs 22 are connected to the right hubs 22 by means of bolts, and the left hubs 22 and the right hubs 22 are symmetrically configured about the tires 21.

Each of the left hubs 22 and the right hubs 22 includes a radial plate 221 and a rim 222 which are integrally formed, where the radial plates 221 of the left hubs 22 and the right hubs 22 are attached to each other, the two radial plates 221 are fixedly connected by means of bolts, the rims 222 of the left hubs 22 and the right hubs 22 are used for sleeving the tires 21, and buffer channels 25 are formed between the tires 21 and the rims 222.

The shaft sleeves 23 use hexagonal pipes, connecting plates 26 are welded to the shaft sleeves 23, and each of the connecting plates 26 is fixedly connected to every two radial plates 221 by means of bolts.

The tires 21 are thick in the middles and thin at both ends in longitudinal sections, and the two ends of the tires 21 are supported by the rims 222.

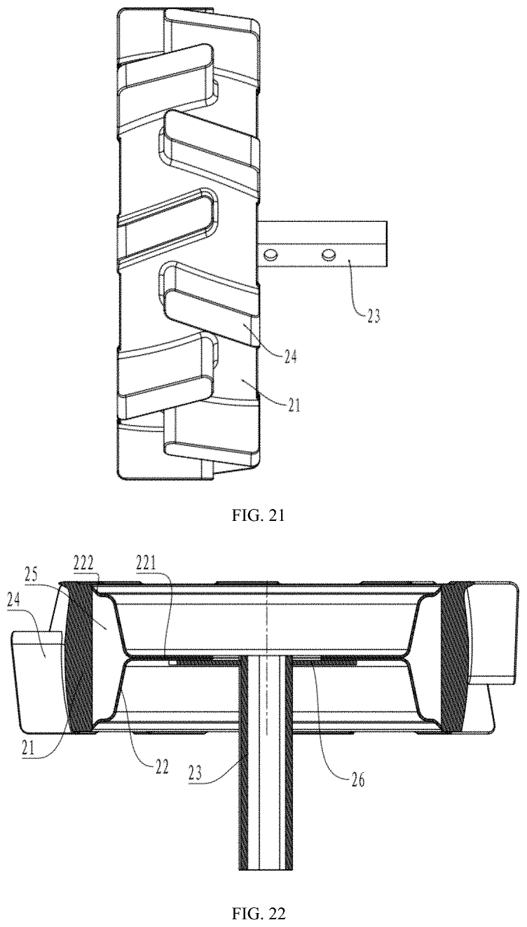

Each of the ground gripping teeth 24 includes a first tooth and a second tooth which are configured in a staggered mode, where the first teeth and the second teeth are obliquely configured relative to central axes of the tires 21, with reference to FIGS. 19 and 21, the first teeth extend to left end surfaces of the tires 21, the second teeth extend to right end surfaces of the tires 21, and portions of the first teeth and the second teeth extending to the end surface of the tires 21 protrude out of end faces of the tires 21.

A specific implementation is as follows:

when this embodiment is adopted, the ground gripping teeth 24 of the traveling wheels 2 are high, and the ground gripping teeth 24 are obliquely configured relative to the shaft sleeves 23, such that the ground gripping teeth may be quickly inserted into the soil, a contact area between the ground gripping teeth 24 and the soil is large, and a ground gripping effect is excellent, thereby addressing abrasion resistance and the ground gripping effect, and moreover, achieving effects of iron wheels and existing common rubber wheels, and significantly improving use cost.

In addition, in this embodiment, widths of the traveling wheels 2 are large, such that the whole traveling wheels 2 have small outer diameters, but have large weight, thereby further improving the ground gripping effect of the traveling wheels 2, and overcoming the defect that dead weight of the light-weight field management machine is reduced, such that the ground gripping force of a light-weight field management machine is weakened.

What is described above is merely the embodiments of the present invention, and general knowledge such as structures and characteristics well known in the solution are not excessively described herein. It shall be noted that for those skilled in the art may further make several transformations and improvements on the premise of not deviating from the structure of the present disclosure, and these transformations and improvements shall fall within the scope of protection of the present disclosure, and may not affect the implementation effect of the present invention and the practicality of the patent. The scope of protection of the present application should be subject to contents of the claims of the present application, and the specific specification and other descriptions in the description may be used for explaining the contents of the claims.

1. A field management machine, comprising a rack, a driver, a transmission, traveling wheels, a cutter and a gear shift lever, wherein the transmission comprises a gearbox and a cutter output shaft and a traveling output shaft which are rotatably connected to the gearbox, the driver is used for driving the cutter output shaft and the traveling output shaft to rotate, the cutter output shaft is used for driving the cutter to rotate, and the traveling output shaft is used for driving the traveling wheels to rotate; a first shift fork for controlling gear shift of the cutter and a second shift fork for controlling gear shift of the traveling wheels are connected to the gearbox, and the gear shift lever comprises a traveling gear shift lever and a cutter gear shift lever, the cutter gear shift lever being connected to the first shift fork, and the traveling gear shift lever being connected to the second shift fork; and the field management machine further comprises a trigger rod located between the cutter gear shift lever and the traveling gear shift lever, the trigger rod being fixedly connected to the cutter gear shift lever or the traveling gear shift lever, and the traveling gear shift lever pushes the trigger rod when the traveling gear shift lever is switched to a reverse gear, such that the cutter gear shift lever is shifted to a state of a neutral gear.

2. The field management machine according to claim 1, wherein the transmission comprises the gearbox, a mounting plate being fixed on the gearbox, strip-shaped limiting holes having the same operation direction as the cutter gear shift lever and the traveling gear shift lever being provided on the mounting plate, the cutter gear shift lever and the traveling gear shift lever being both located in the strip-shaped limiting holes, and the trigger rod being located below the mounting plate.

3. The field management machine according to claim 1, wherein a main shaft is rotatably connected to an interior of the gearbox, and is connected to an output end of the driver, a shift gear is axially and slidably connected to the main shaft, the first shift fork is used for pushing the shift gear to move axially, and a fixed gear engaging with the shift gear is fixedly connected to the cutter output shaft; and a main gear is further fixedly connected to the main shaft, a transmitting gear further sleeves the cutter output shaft in an empty mode, auxiliary gears is mounted on the traveling output shaft, and the transmitting gear engages with the main gear and the auxiliary gears.

4. The field management machine according to claim 3, wherein the transmitting gear comprises a first transmitting gear and a second transmitting gear which sleeve the cutter output shaft in an empty mode, the auxiliary gears comprise a first auxiliary gear and a second auxiliary gear, the first auxiliary gear sleeves the traveling output shaft in an empty mode, the second auxiliary gear being axially and slidably connected to the traveling output shaft, the second shift fork is used for pushing the second auxiliary gear to move in an axial direction, and the first transmitting gear, the second transmitting gear and the first auxiliary gear each comprise a large gear and a pinion which are fixedly connected, the large gear of the first transmitting gear engaging with the main gear, the pinion of the first transmitting gear engaging with the large gear of the first auxiliary gear, the pinion of the first auxiliary gear engaging with the large gear of the second transmitting gear, and the pinion of the second transmitting gear being capable of engaging with the second auxiliary gear.

5. The field management machine according to claim 1, wherein the cutter comprises a left cutter assembly and a right cutter assembly which are symmetrically mounted, the left cutter assembly and the right cutter assembly each comprising a blade shaft and a plurality of blades, the plurality of blades being sequentially distributed in an axial direction of the corresponding blade shaft, an axial distance between adjacent blades being equal, the plurality of blades being uniformly distributed on a vertical surface of the corresponding blade shaft in a circumferential direction of the blade shaft by 360°, and the plurality of blades on the same blade shafts facing the same directions.

6. The field management machine according to claim 5, wherein blade boxes are fixed on the blade shafts, the number of the blade boxes is the same as that of the blades, insertion holes are provided on the blade boxes, blade handles of the blades are inserted into the insertion holes, and the blades are detachably connected to the blade boxes.

7. The field management machine according to claim 6, wherein the blade shafts are in a shape of a regular polygon, the number of edges of each of the blade shafts is the same as that of the blades mounted, and the blade boxes make contact with two adjacent surfaces of the blade shafts simultaneously.

8. The field management machine according to claim 5, wherein connecting lines of the plurality of blades on each of the blade shafts are two spiral lines, an included angle between the two spiral lines is 180°, and a distance between end projections of the two spiral lines in an axial direction of each of the blade shafts is equal to the distance between adjacent blades.

9. The field management machine according to claim 1, wherein each of the traveling wheels comprises a tire and hubs, the tires sleeving the hubs, a plurality of ground gripping teeth being configured on a tread of each of the tires and being distributed in a circumferential direction of the tire, tooth heights of the ground gripping teeth being 0.15 time-0.28 time of radii of the treads, and widths of the hubs being 0.3-0.45 times of diameters of the treads of the tires.

10. The field management machine according to claim 9, wherein the tires are solid tires, the tires are thick in middles and thin at both ends in longitudinal sections, and the two ends of the tires are supported by rims.
